(19) United States
(12) Patent Application Publication
(10) Pub. No.: US 2020/0093263 A1
(43) Pub. Date: Mar. 26, 2020

(54) AN ADJUSTABLE MOUNT FOR AN IMAGE PROJECTOR

(71) Applicant: DNP Denmark A/S, Karlslunde (DK)

(72) Inventors: Søren Weis Lindegaard, Køge (DK); Behnam Chabokirayeni, Ringsted (DK); Johnny Jensen, Karise (DK); Jen Krabbe Frandsen, Copenhagen NV (DK); Mike Fabricius Smedegaard, Århue C (DE); Ebbe Folke Nielsen, Rønde (DK)

(21) Appl. No.: 16/616,193

(22) PCT Filed: May 18, 2018
(86) PCT No.: PCT/DK2018/050110

§ 371 Date: Nov. 22, 2019

(30) Foreign Application Priority Data
May 22, 2017 (DK) PA 2017 70363

(51) Int. Cl. A47B 81/06; F16M 13/02; F16M 11/12; G03B 21/54

(52) U.S. Cl. CPC A47B 81/065; G03B 21/54; F16M 11/121; F16M 13/02

(57) ABSTRACT

The adjustable mount comprises a baseplate, a platform separated from the base by at least three columns, and a mounting element adapted for engagement with the image projector. The columns are at a first end connected to one of said platform or said baseplate, and remote from said first end pass through apertures in the other. The apertures comprise, a first circular aperture with a diameter corresponding essentially to the diameter of the column passing through it, a second circular aperture with a diameter larger than the diameter of the column passing through it, a third elongate aperture having a length and a width, where length is longer than the diameter of the column passing through it and where the width corresponds essentially to the diameter of the column passing through it.

### CROSS-REFERENCES TO RELATED APPLICATIONS

The present application is a national stage entry of International Patent Application No. PCT/DK2018/050110, filed May 18, 2018, entitled “AN ADJUSTABLE MOUNT FOR AN IMAGE PROJECTOR.” This application claims the benefit of Danish Patent Application No. PA 2017 70363, filed May 23, 2017, entitled “AN ADJUSTABLE MOUNT FOR AN IMAGE PROJECTOR.”

### BACKGROUND

The present invention relates to an adjustable mount for an image projector, a piece of furniture with such an adjustable mount and an image projection system with such a piece of furniture.

In recent years image projectors have gained in popularity both for private and commercial use. In particular, short throw projectors, i.e. projectors projecting the image onto the front projection screen in an acute angle are gaining in popularity, because the system of image projector and projection screen does not take up much space, and is less prone to be blocked by a person in front of the screen, as compared traditional projectors projecting onto the front projection screen at an angle much closer to perpendicular.

If the image projected onto the screen needs to have a good and aesthetically pleasing appearance—and it does, the projected image must hit the front projection screen very precisely. Distorted images, and images projected onto the surface next to the front projection screen are to be avoided. Moreover, for an aesthetical appearance and protection it is furthermore desirable if the image projector can be hidden away when not in use. In this respect, however, the acute projection angle poses some problems in precision, and reproducibility thereof, because it takes much less disturbance of the position of the image projector before the image is distorted and improperly projected onto the front projection screen.

### SUMMARY

On this background, the present invention sets out to provide a mount which allows the image projector to be precisely positioned with respect to the front projection screen, and in particular precisely positioned in a reproducible manner, even when the image projector is located in a movable manner in a piece of furniture, allowing it to be stowed away when not in use.

According to a first aspect of this disclosure, this object is achieved by an adjustable mount for an image projector, the adjustable mount comprising a base, a platform separated from the base by at least three columns with a generally circular cross-section, and a mounting element adapted for engagement with the image projector, where at least some of the columns are adjustable, so as to define a desired spacing between the base and the platform, where said at least three columns are at a first end connected to one of said platform or said base, and remote from said first end pass through apertures in the other of said platform or said base for adjustable engagement, wherein at least some of said apertures have a geometry with a diameter of an inscribed circle larger than the diameter of the column passing through it.

By providing the three apertures for the three respective columns in these shapes and dimensions, i.e. dimensions larger than the nominal diameter of the columns, it becomes possible to accommodate for changes in the angles of the columns with respect to the base, when their effective lengths are changes, and therefore the base and the platform turn away from being in parallel with respect to each other. In particular, some of the three apertures may be provided with much less precision, e.g. as compared to purely circular apertures, in turn leading to cost reduction. So by allowing the columns to change their angles in this way, it becomes easy to adjust the angle of the platform with respect to the front projection screen in a well-defined manner, simply by adjusting the effective lengths of columns.

According to an illustrative example according to the first aspect of this disclosure the apertures comprise a first aperture with a diameter of the inscribed circle corresponding essentially, i.e. nominally, to the diameter of the column passing through it, a second aperture with a diameter of an inscribed circle larger than the diameter of the column passing through it, a third elongate aperture having a length and a width, where the length is longer than the diameter of the column passing through it and where the width corresponds essentially to the diameter of the column passing through it. This still allows some of the three apertures to be provided with much less precision, as compared to purely circular apertures, while securing and maintaining the adjusted angle of the platform with respect to the front projection screen in and even better defined manner. This may still simply be done by adjusting the effective lengths of columns, and it still leads to a significant cost reduction.

According, to an illustrative example, at least one of the first or second aperture, and possibly both, has a circular shape so that the diameter of the inscribed circle corresponds to the diameter of said first and/or second aperture, or in other words when the geometry of the aperture is circular the inscribed circle is coincident with the periphery of the circular aperture. Circular shaped apertures are easy to provide with great precision in a cost-efficient manner, e.g. by drilling or punching.

According to an illustrative example according to the first aspect of this disclosure, the columns comprise a threaded surface and nuts with a matching thread, so as to adjust an effective length of said columns defining said desired spacing. This provides a simple, efficient and intuitive adjustment.

According to another illustrative example according to the first aspect of this disclosure, biasing springs are provided between said base and said platform. By biasing the base and the platform apart, only one adjustment nut is needed per column to adjust the effective length thereof because the base or the platform, as the case may be, is then retained in one direction along the columns by the biasing spring, and in the other by the nut, which is itself displaceable along the column.

According to another illustrative example according to the first aspect of this disclosure, apertures are provided in the base. This allows the adjustment nuts to be easily accessible, even with the image projector in position on the mounting element.

According to yet another illustrative example according to the first aspect of this disclosure, the mounting element extends in parallel to said platform and said mounting element is adapted to be at least displaceable in parallel with respect to said platform, and wherein at least one releasable securing member is provided. This allows the image projector to be moved forward, backward and sideways with respect to the projections screen, and then be fixed at a desired distance and angle, where the size of the projected image matches the size of the front projection screen, upon which the position, angle etc. may be accurately adjusted by adjustment of the effective length of the columns. In other words, providing a possibility of coarse adjustment before fine adjustment.

According to yet another illustrative example according to the first aspect of this disclosure, the base comprises a further access aperture is adapted to adapted to allow access to the at least one releasable securing member. This allows easy access to readjustment coarse adjustment of the image projector.

According to a second aspect of this disclosure the object is achieved by a piece of furniture provided with an adjustable mount according to any one of the examples above. Thereby it becomes possible to arrange the mount in an easy, well-defined, and preferably inconspicuous manner in close relationship to the front projection screen. The latter is in particular the case when according to an illustrative example of the second aspect of this disclosure, said adjustable mount is provided in a drawer movable with respect to a body of said piece furniture between a closed position and an open position.

According to a further example according to the second aspect of this disclosure, the piece of furniture comprises mutually engaging elements adapted to secure the drawer in the open position. This allows the drawn-out drawer to be arrested in a reproducible, accurate and well-defined position, in turn ensuring the correct positioning of the image projector with respect to the front projection screen when in use.

According to another illustrative example of according to the first aspect of this disclosure, said mutually engaging elements comprise magnets. Magnetic attraction provides a good engagement between the elements which, though it may be overcome by the user pushing the drawer back in after use, suffices to maintain the drawer and hence the image projector in the desired well-defined position.

According to an illustrative example according to the third aspect of this disclosure, there is provided a system comprising a front projection screen and a piece of furniture. This allows the front projection screen to be generally matched to the position of the image projector in advance, e.g. in proper size, and allowing supply of a piece of furniture with an already—at least coarsely, adjusted image projector.

According to another illustrative example according to the third aspect of this disclosure, the front projection screen and the piece of furniture are secured to one and the same wall. This makes the image projection system less prone to external disturbances. That is inter alia to say, with both mounted on the same wall or building structure, it becomes less likely that someone moves the furniture and hence the image projector out of position with respect to the front projection screen, e.g. inadvertently bumping into it or shoving is with a vacuum cleaner or the like. Furthermore, being mounted on the same structure they are more likely to move together, e.g. if the weight of a passing person on the floor causes the wall to move, thus minimizing the disturbance.

### BRIEF DESCRIPTION OF THE DRAWINGS

The principles of this disclosure are described in greater detail based on non-limiting examples and with reference to the drawings, of which:

FIG. 1 shows an interior decoration with a system according to the principles described herein,

FIG. 2 shows a piece of furniture according to the principles described herein,

FIG. 3 shows a top plan view of a piece of furniture according to the principles described herein with an open drawer in which an adjustable mount according to the principles described herein is mounted,

FIG. 4 shows a cross-section of a piece of furniture according to the principles described herein with an open drawer for accommodating an adjustable mount according the principles described herein,

FIG. 5 shows a top plan view of the adjustable mount according to the principles described herein,

FIG. 6 shows a perspective top view of the adjustable mount according to the principles described herein,

FIG. 7 shows a side view of the adjustable mount according to the principles described herein,

FIG. 8 shows a perspective bottom view of the adjustable mount according to the principles described herein,

FIG. 9 shows an exploded view of the adjustable mount according to the principles described herein, and

FIG. 10 shows a top plan view of the baseplate of the adjustable mount according to the principles described herein.

### DETAILED DESCRIPTION

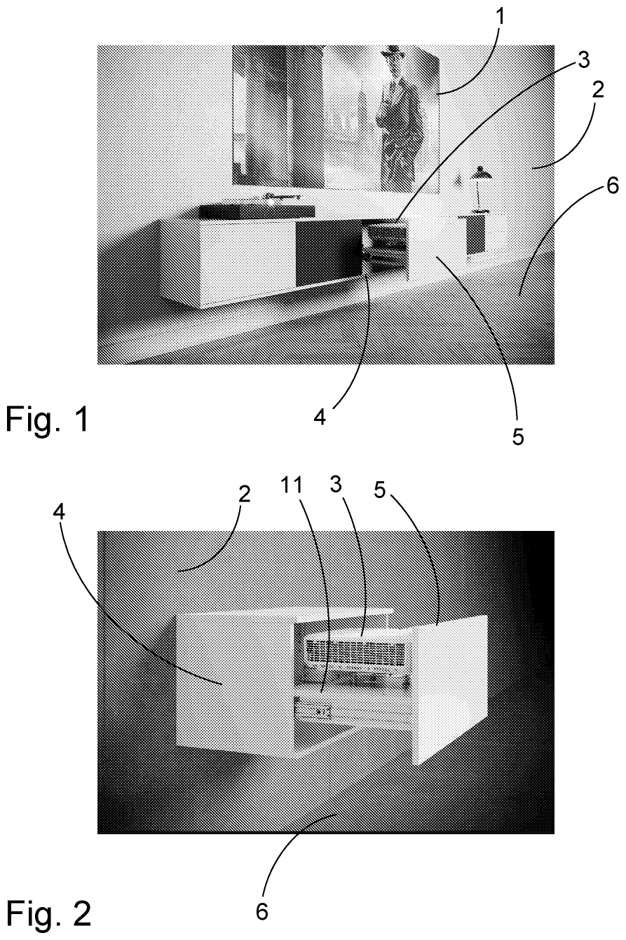

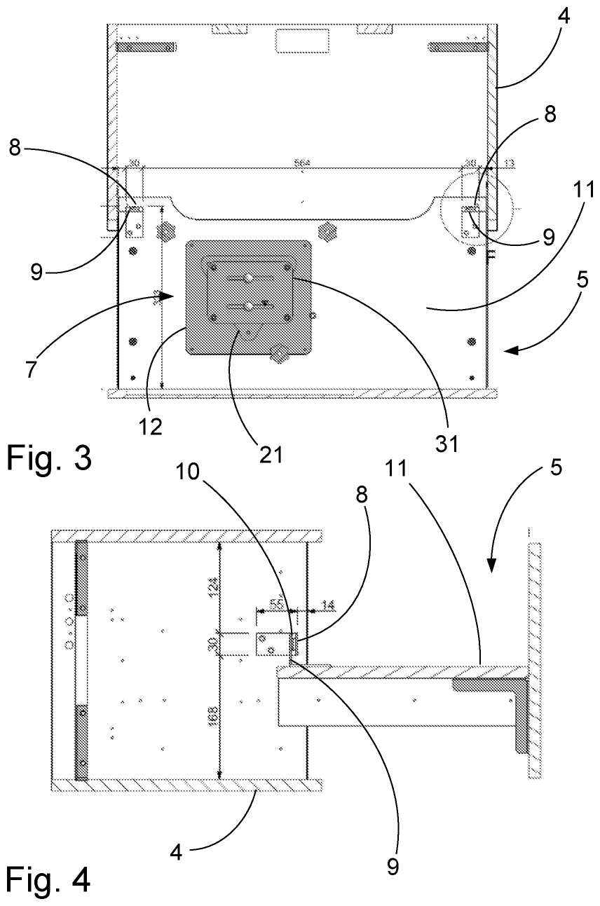

Turning first to FIG. 1 an image projection system according to this disclosure is shown. The image projection system comprises a front projection screen 1 mounted on a wall 2. An image projector is 3 is mounted in a piece of furniture 4. More specifically the image projector is mounted in a drawer 5 of the furniture, so that it is hidden and protected when not in use and the drawer is closed. Since, however, the present invention is related to the positioning of the image projector 3 with respect to the front projection screen 1, the drawer 5 is only shown in the open position. As can be seen the piece of furniture 4 is also mounted on the wall 2. Having both the front projection screen 1 and the piece of furniture 4 mounted on one and the same wall, means that they move together under external influences, say if the weight of a passing person on the floor 6 causes the wall to move, in turn minimizing the disturbance. As can be seen from FIG. 2 in comparison with FIG. 1 the piece of furniture may be a modular piece of furniture 4 forming part of a larger interior decoration. Though shown mounted on the wall 2 well above the floor 6 it is of course not excluded that the piece of furniture 4 could be resting on the floor 6. This in turn does not exclude that the piece of furniture 4 could still be affixed to the wall 2. It is currently preferred that the image projector 3 is located in a drawer 5 which can be drawn in a translatory motion from a closed position to the open position shown in FIGS. 1 and 2 as well as FIGS. 3 and 4. It is however not excluded that the image projector could be mounted on a shelf attached in a suitable manner to a bottom hinged door. It is of course also not excluded that the piece of furniture 4 with the image projector could be mounted upside down on the wall 2 above the projection screen 1, or on the ceiling above the projection screen 1 or even secured to both. This, however, could make the adjustment more difficult, as it would most likely involve work on a platform or a ladder as well as a somewhat awkward working position. For convenient daily use it would in that case also be advantageous to provide a preferably remote controlled motorized drive for opening and closing the drawer 5. Such arrangements are however not relevant for the present invention as such.

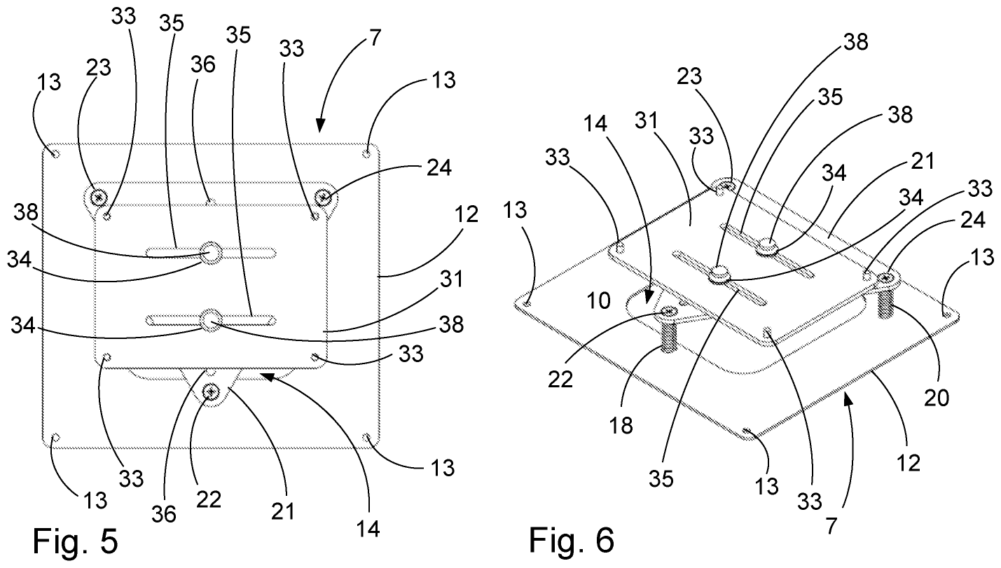

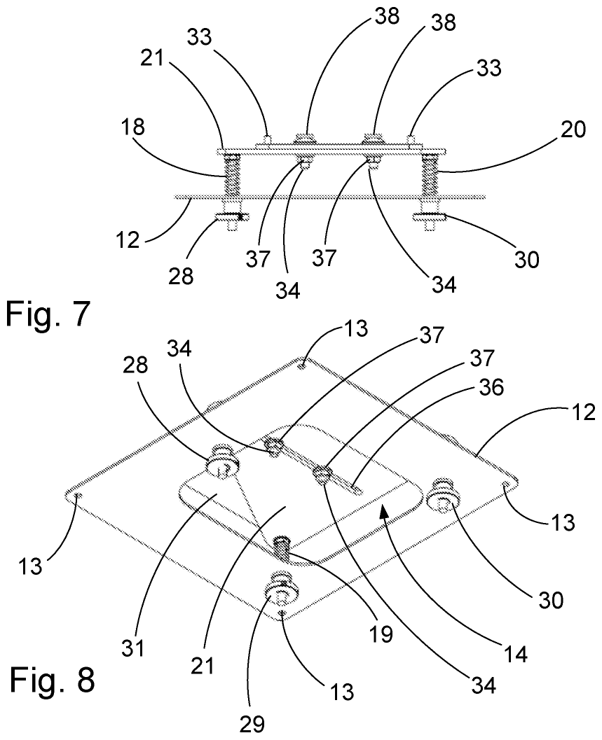

Turning now to FIG. 3 a top view of a cross section through the piece of furniture 4 with the drawer 5 in an open position is shown. In the drawer 5 an adjustable mount 7 for the image projector 3 is located. The adjustable mount 7 will be described later in conjunction with FIGS. 5 to 10. As can be seen the adjustable mount 7 is offset to the left with respect to the drawer 5. This ensures symmetry, when, as is the case of the currently preferred short throw projector, the image projector is itself asymmetrical. That is to say, a centre line of the piece of furniture 4 can be aligned with the centre line of the front projection screen 1 so that a symmetrical aesthetic appearance of the interior decoration, e.g. as shown in FIG. 1, is achieved. Evidently, if the image projector 3 was not asymmetrical the adjustable mount 7 would be located on the centre line of the piece of furniture 4 too.

As can be seen in FIGS. 3 and 4 the drawer 5 and the body of the piece of furniture 4 are fitted with a pair of brackets 8, 9, or preferably two pairs of brackets 8, 9, each bracket 8, 9 of a pair located at a right angle to the other with one bracket 8 extending vertically sideways from the body of the piece of furniture 4, and one bracket 9 extending vertically upward from the bottom 11 of the drawer 5. The respective vertical planes of the two brackets extend in parallel and the brackets 8, 9 register so that an end stop of the drawer 5 in the open position is provided. To ensure that the open drawer 5 stays in a well-defined open position, the pair of brackets 8, 9 is provided with suitable arresting means. Preferably the arresting means comprises at least one permanent magnet 10, but preferably a pair of oppositely polarized magnets 10 is used, one on each bracket 8, 9. However, if, as would normally the case, the brackets 8, 9 are made of magnetic material comprising iron, one magnet 10 would suffice, the opposing bracket serving as the attracted counterpart. Between the at least one magnet 10 and the counterpart, be it a bracket 8, 9 or another magnet 10, a cushioning member such as a piece of felt could be arranged to provide a gap dampening the engagement and reducing the magnetic attraction for less abrupt engagement and disengagement of the brackets 8, 9. All mechanical shocks and other abrupt motions are undesired, as they could dislocate the image projector 3 from its finely adjusted desired position. Instead of magnets 10, other known mechanical arresters such as elastic latches could be used, but magnets are currently preferred, for simplicity and lack of abrupt movements.

Turning now to FIG. 5 to 9 an illustrative example of the adjustable mount 7 according to this disclosure is shown. The adjustable mount 7 has a base provided by a generally rectangular baseplate 12 made of a suitable material such as steel. In each corner a hole 13 is provided for mounting screws, allowing it to be secured to the bottom 11 of the drawer 5. As can be seen from FIG. 2, the bottom of the drawer 5 may have a suitable recess matching the thickness and overall dimensions of the baseplate 12 allowing the upper side of the baseplate to lie flush with the bottom 11 of the drawer. Though not visible, this recess is preferably a shoulder of a ledge surrounding a cut-out in the bottom 11 of the drawer 5, the cut-out allowing access to the lower side of the baseplate 12 and preferably also through a large central aperture 13 of the baseplate 12 for adjusting the adjustable mount 7, e.g. by a hand or a tool. From the baseplate 12 three columns 15, 16, 17 extend. The column 15, 16, 17 themselves are best seen in the exploded view of FIG. 9, as in the other depictions they are surrounded by helical coil springs 18, 19, 20. At one end, each column 15, 16, 17 is rigidly connected to a generally triangular platform 21 rising over the baseplate 12. The triangular platform 21 is preferably made of a material with suitable rigidity such as steel. From the description to follow, the skilled person will realize that the triangular shape of the platform 21 is only preferred, and that other suitable shapes exist, e.g. a T-shaped platform 21 could be used instead. The three columns 15, 16, 17 preferably are rigidly connected to the triangular platform 21 at a respective corner thereof. The connection could be any suitable connection, but currently a connection by screws 22, 23, 24 into suitable bores (not visible) of the columns through holes at the respective corners of the platform 21 are preferred.

The columns 15, 16, 17 are preferably provided with an external thread. The columns 15, 16, 17, or at least a treaded part thereof, extend though three apertures 25, 26, 27. On the opposite side of the baseplate 12 with respect to the platform 21 the thread is engaged by a corresponding internal thread of a respective nut 28, 29, 30. The nuts 28, 29, 30 thus serve as stops for the baseplate 12 at each column 15, 16, 17 when the baseplate 12 is biased away from the platform 21 by the helical coil springs 18, 19, 20. By turning the nuts 28, 29, 30 the effective length of the columns, i.e. the distance between the baseplate 12 and the platform 21 at each column 15, 16, 17 thereby becomes adjustable. Evidently the force of the springs is adapted to the weight of the image projector to be mounted, so as to ensure the spaced apart position of the baseplate 12 and the platform 21. Also, the force of the springs is adapted to ensure that the columns 15, 16, 17 do not displace themselves laterally in those of the apertures 25, 26, 27 that have larger minimum dimensions than the respective column 15, 16, 17 passing through it. In order to not need any excessive spring force for this, friction elements 39 engaging the baseplate 12 (or the platform 21) are provided. As can best be seen in the exploded view of FIG. 9, these friction elements 39 are preferably located between the nuts 28, 29, 30 so that they are sandwiched between a nut 28, 29, 30 and the baseplate 12. Since each of the nuts 28, 29, 30 is generally tightly fitted to the respective column 15, 16, 17, the friction between friction element 29 the baseplate 12 as well as the respective nut 28, 29, 30 will prevent the respective column 15, 16, 17 from moving laterally with respect to the baseplate 12. The friction elements 29 are preferably discs or washers of a suitable friction material such as rubber or a soft plastic material, but the skilled person will know of other suitable materials. Preferably, the friction elements have a central perforation adapted to the diameter of the columns 15, 16, 17 so as to surround it without any lateral play between the friction element 29 and the column 15, 16, 17 it surrounds. As to the helical coil springs 18, 19, 20 it should be mentioned that this is merely a possible example. Evidently, they do neither need to be coil springs nor do they need to be located at or surrounding the columns 15, 16, 17 or even match the columns 15, 16, 17 in their number.

As an alternative to the spring biasing, threaded nuts (not shown) could be arranged on the threaded columns 15, 16, 17 between the baseplate 12 and the platform 21. By turning these nuts, the effective length of the columns could be adjusted, and the baseplate 12 (or the platform 21 as the case may be) be biased against these nuts, by means of the nuts 28, 29, 30 to firmly secure the position of the platform 21 with respect to the baseplate 12.

The nuts 28, 29, 30 are preferably finger nuts with a knurled or grooved surface for increased friction, or wingnuts for easy manual operation as they serve to adjust the effective length of the columns 15, 16, 17, and hence the height of the platform 21 over the baseplate at the columns 15, 16, 17. Obviously, other kinds of nuts may be used, e.g. conventional hexagonal nuts. Since the effective length of each of the columns 15, 16, 17 may be individually adjusted, the angle of the platform 21 with respect to baseplate 12 may thereby be adjusted so that the image of the image projector 3 mounted on the adjustable 7 is accurately aligned with the front projection screen 3.

However, in order to coarsely adjust the alignment, as well as the size of the image, the adjustable mount 7 has a further adjustment feature in the form of a mounting element 31 adapted to lie in parallel engagement with the platform 21 and on top of it. The mounting element 31 preferably comprises a sufficiently rigid plate, such as a steel plate, adapted in size with the mounting means of the image projector 3. That evidently depends on the image projector 3, but in one possible example the mounting element is a generally rectangular plate with holes 32 in each corner through which mounting screws 33 may be inserted into corresponding threaded bores in the image projector and tightened for secure engagement with the image projector 3.

Having secured the image projector 3 to the mounting element 31, the mounting element 31 may, guided by a number of bolts 34, be displaced in one direction with respect to the platform 21 along one or more elongated slits 35 provided in the mounting element 31, and in a cross-wise direction thereto along at least one elongated slit 36 provided in the platform 21. The length of the at least one elongated slit 36 is preferably longer than the distance between the slits 35, so as also allow rotary motion of the mounting element 31 with respect to the platform 21. When the desired position and angle is reached, the mounting element 31 may be secured in that position and angle on the platform 21 by means of nuts 37 or the like. To easily access these nuts 37 a large central aperture 14 is provided in the baseplate 12, as will inter alia be apparent from FIG. 8. Preferably, small disks 38 of felt or the like are attached to the heads of the bolts 34. They inter alia keep the heads of the bolts 34 sandwiched between the mounting element 31 and the image projector 3, in turn, ensuring that the bolts 34 remain somewhat in place with perpendicular orientation with respect to the mounting element 31 when the latter is slid along the platform 21.

When the coarse positioning has been effected, the fine positioning may be performed by use to the adjustment nuts 28, 29, 30. However, when the effective lengths of the columns 15, 16, 17 are changed during the fine positioning, the change of the angle of the platform 21 with respect to the baseplate 12 will generally have a tendency to change the angle of the individual columns 15, 16, 17 in an uncontrolled manner. That is to say the columns 15, 16, 17 will be forced towards a position where they are not perpendicular to the baseplate 12 in an uncontrolled manner. One way of countering this would be to manufacture the apertures 25, 26, 27 in the baseplate to a high precision matching closely the diameter of the threaded columns 15, 16, 17. High precision and small tolerances are, however, costly in the manufacture, and according to this disclosure this is instead countered by the use of three apertures differing from each other.

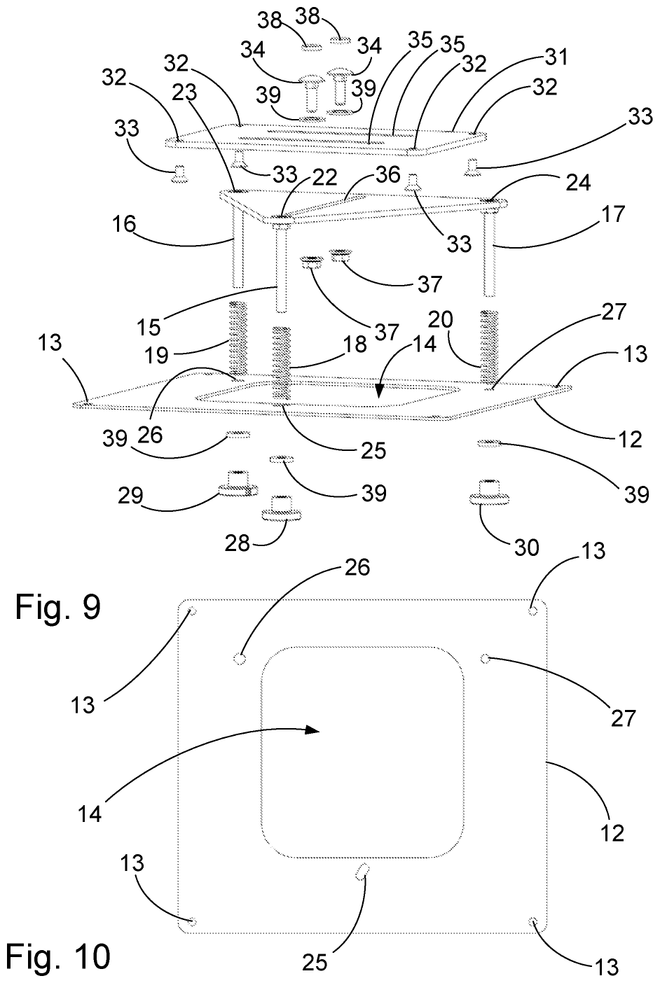

Accordingly, as can be seen in FIG. 10, the first aperture 27 is a circular aperture with a diameter corresponding essentially to the nominal diameter of the first column 17, e.g. no more than 5.15 mm for a 5 mm diameter of the threaded column 17 or in relative terms less than 3% over dimension. The second aperture 26 is a circular aperture with a diameter larger than the diameter of the column 16 passing through it, e.g. up to 6.5 mm for a 5 mm diameter of the threaded column 16 or in relative terms up to 30% over dimension with respect to the nominal diameter of the threaded column 16. This allows some angular play of the first column 17 in the first aperture 27, i.e. allowing for a slight rotation. However, this angular play it largely hindered by the shape of the third aperture 25, which is an elongate aperture having a length and a width, where length is longer than the diameter of the third column 15 passing through it and where the width corresponds essentially to the diameter of the third column 15 passing through it, e.g. no more than 5.15 mm width for a 5 mm diameter of the threaded column 17 or in relative terms less than 3% over dimension. With this arrangement a good control and predictability of the way the columns 15, 16, 17 change their angle with respect to the baseplate 12 is achieved, without involving the high cost of fine tolerances in manufacture.

It should be noted though, that even if for reasons of manufacture circular apertures 26, 27 are preferred, they could in fact be substituted with any suitable geometry in particular regular polygonal shapes, such as triangular, square, pentagonal or even star-shaped. In that case it would obviously not be the diameter, which has to be adapted to the diameter of the column 16, 17, but instead the diameter of the inscribed circle. When, in that case, at least one of the first and second apertures is polygonal, the above dimensions would apply equally to the inscribed circles. It must, however, be emphasized that these values are merely examples, exemplifying the relevant precision.

Thus with the above, a new and inventive solution for mounting an image projector 3 in correct position with respect to a front projection screen 1. This solution provides several aspects of increased precision leading to advantages of not only the involved components but also of the overall system itself.

It should be noted though that what has been described is a set of illustrative examples of the components and system, for which the skilled person will easily see variants without departing from the scope of this disclosure. In particular, the skilled person will understand that deviations from the rectangular and triangular shapes if the baseplate 12, mounting element 31 and platform 21 are possible. Locations of holes, slits and apertures may also be altered. E.g. the columns 15, 16, 17 could be rigidly connected to the baseplate 12 and movable with respect to the platform 21.

Furthermore, the bottom 11 of the drawer 5 could be constituted by anything suitable for supporting the base, albeit it is currently preferred that the bottom 11 with base in the form of the baseplate 12 is a contiguous structure allowing objects to be placed and stored next to the image projector 3, such a remote control for the image projector 3, lens cleaning equipment etc. so as to be hidden away together with the image projector 3 when not in use. On the other hand, the bottom 11 of the drawer 5 could itself form the base rather than having a separate embedded baseplate 12.

It should also be noted that the platform 7 may of course also be used without the piece of furniture 4 and the drawer 5, in particular if it is placed in an inconspicuous manner, say below the ceiling of a room, with the projector below it, in which case it would largely be obscured by projector 3 and thus invisible.

What is claimed is:

1. An adjustable mount for an image projector, the adjustable mount comprising:
a base, a platform separated from the base by at least three columns comprising a generally circular cross-section having a diameter, and a mounting element adapted for engagement with the image projector,
where at least some of the columns are adjustable, so as to define a spacing between the base and the platform,
where said at least three columns are at a first end connected to one of said platform or said base, and remote from said first end pass through apertures in the other of said platform or said base for adjustable engagement,
wherein each aperture comprises a geometry corresponding to an inscribed circle comprising a diameter, and wherein the geometry of at least some of said apertures is such that the diameter of the inscribed circle corresponding to each aperture of the at least some of said apertures is larger than the diameter of one of the at least three columns passing through that aperture.

2. The adjustable mount according to claim 1, wherein said apertures comprise:
a first aperture through which a first column of the at least three columns passes, wherein the diameter of the inscribed circle of the first aperture corresponds essentially to the diameter of the first column,
a second aperture, through which a second column of the at least three column passes, wherein the diameter of the inscribed circle of the second aperture is larger than the diameter of the second column, and
a third elongate aperture through which a third column of the at least three columns passes, the third elongate aperture having a length and a width, wherein the length of the third elongate aperture is longer than the diameter of the third column, and wherein the width of the third elongate aperture corresponds essentially to the diameter of the third column.

3. The adjustable mount according to claim 2, wherein at least one of the first aperture or the second aperture, has a circular shape such that the diameter of the inscribed circle of the first aperture corresponds to a diameter of said first aperture or the diameter of the inscribed circle of the second aperture corresponds to a diameter of said second aperture.

4. The adjustable mount according to claim 1, wherein each column of the at least three columns comprises a threaded surface and a nut with a threading matching the threaded surface, wherein an effective length of each column of the at east three columns is adjustable via the nut to define said spacing.

5. The adjustable mount according to claim 1, further comprising biasing springs between said base and said platform.

6. The adjustable mount according to claim 1, further comprising friction elements.

7. The adjustable mount according to claim 1, wherein the apertures are provided in the base.

8. The adjustable mount according to claim 1, wherein said mounting element extends in parallel to said platform and said mounting element is adapted to be at least displaceable in parallel with respect to said platform, and further comprising at least one releasable securing member is provided.

9. The adjustable mount according to claim 8, wherein the base comprises a further access aperture is adapted to allow access to the at least one releasable securing member.

10. A piece of furniture, comprising:
a body; and
an adjustable mount coupled with the body, the adjustable mount comprising:
a base, a platform separated from the base by at least three columns comprising a generally circular cross-section having a diameter, and a mounting element adapted for engagement with the image projector,
where at least some of the columns are adjustable, so as to define a spacing between the base and the platform,
where said at least three columns are at a first end connected to one of said platform or said base, and remote from said first end pass through apertures in the other of said platform or said base for adjustable engagement,
wherein each aperture comprises a geometry corresponding to an inscribed circle comprising a diameter, and wherein the geometry of at least some of said aperture is such that the diameter of the inscribed circle corresponding to each aperture of the at least some of said apertures is larger than the diameter of one of the at least three columns passing through that aperture.

11. The piece of furniture according to claim 10, wherein said adjustable mount is disposed in a drawer movable with respect to said body of said piece furniture between a closed position and an open position.

12. The piece of furniture according to claim 11, wherein the piece of furniture comprises mutually engaging elements adapted to secure the drawer in the open position.

13. The piece of furniture according to claim 12, wherein said mutually engaging elements comprise magnets.

14. An image projection system comprising:
a front projection screen;
a piece of furniture comprising a body and an adjustable mount coupled with the body and configured to support the front projection screen, wherein the adjustable mount comprises:
a base, a platform separated from the base by at least three columns comprising a generally circular cross-section having a diameter, and a mounting element adapted for engagement with the image projector,
wherein at least some of the columns are adjustable, so as to define a spacing between the base and the platform,
wherein said at least three columns are at a first end connected to one of said platform or said base, and remote from said first end pass through apertures in the other of said platform or said base for adjustable engagement,
wherein each aperture comprises a geometry corresponding to an inscribed circle comprising a diameter, and wherein the geometry of at least some of said apertures is such that the diameter of the inscribed circle corresponding to each aperture of the at least some of said apertures is larger than the diameter of one of the at least three columns passing through that aperture.

15. The image projection system according to claim 14, wherein the front projection screen and the piece of furniture are secured to a same wall.
